(19) United States
(12) Patent Application Publication
(10) Pub. No.: US 2025/0086893 A1
(43) Pub. Date: Mar. 13, 2025

(54) AUTOMATIC AND DYNAMIC GENERATION OF MODELLING INPUTS BASED ATLEAST UPON A DEFINED SET OF RENDERING VARIABLES, AND RENDERING A RECONSTRUCTED AND OPTIMIZED MODEL IN REALTIME

(71) Applicant: ADLOID TECHNOLOGIES PRIVATE LIMITED [, New Delhi (IN)

(72) Inventors: Kanav SINGLA, Patiala (IN); Kartik KANAUJIA, Gurgaon (IN); Rohit RANJAN, Gurgaon (IN); Ankit YADAV, Rewari (IN)

(21) Appl. No.: 18/725,549

(22) PCT Filed: Jan. 2, 2023
(86) PCT No.: PCT/IN2023/050002

§ 371 Date: Jun. 28, 2024

(30) Foreign Application Priority Data
Dec. 31, 2021 (IN) 202111055448

(51) Int. Cl. G06T 17/20; G06T 15/04

(52) U.S. Cl. CPC G06T 17/205; G06T 15/04; G06T 2210/32

(57) ABSTRACT

A system and method for automatic and dynamic generation of modelling inputs based atleast upon a defined set of rendering variables, and rendering a reconstructed and optimized model in realtime is described.

### BACKGROUND

### Technical Field

The present invention relates generally to three dimensional modelling and more particularly to processing and representation of an object on a computer interface.

### Background of the Invention

The field of computer modelling gained increased importance especially during the industrial expansion of the 20th century. It allowed creators to overcome the barrier of creating various versions of objects and equipments that may/may not be present in the real world, and visualization thereof.

Planning, modification, optimization and after effects were all easily accounted for by use of modelling systems before taking up actual construction of any project. Civil engineering and astronomical advancements also had a lot to gain from modelling of the three dimensional space.

The late twentieth century and the twenty-first century has seen a further increase in the field with increased use in virtual reality, augmented reality, and mixed reality technologies. However, one of the major challenges to creating a 3D virtual reality environment is the complexity of generating the output for all possible positions and orientations of the viewer and for a variety of user devices. These two have a significant effect on the rendering of the three dimensional image since the processing requirement of such an image is considerably high. As these stereo images must be generated dynamically in almost real-time as the user virtually moves through the virtual reality environment, the complexity is further compounded. This requirement distinguishes 3D virtual reality from the process of generating 3D movies from 2D images as the location of the viewer is essentially fixed at the location of the camera.

JP4271236B2 proposes a solution by allegedly providing for affording a real-time three-dimensional interactive environment using a three-dimensional camera. As per the disclosure provided the invention allegedly includes obtaining two-dimensional data values for a plurality of pixels representing a physical scene, and obtaining a depth value for each pixel of the plurality of pixels using a depth sensing device. Each depth value indicates a distance from a physical object in the physical scene to the depth sensing device. At least one computer-generated virtual object is inserted into the scene, and an interaction between a physical object in the scene and the virtual object is detected based on coordinates of the virtual object and the obtained depth values. However, details of realtime environment parameters and rendering based on level of details needed may not be provided.

CN104766366B proposes a kind of method for building up of, three-dimension virtual reality demonstration, solve the problems, such as highway three-dimensional modeling and digital elevation model seamless link, route topography three-dimensional visualization be related to terrain modeling and road modeling and how split that the two is seamless the problems such as various modeling method and techniques are applied in three-dimensional road modeling and visualization, according to the flat, vertical, horizontal data of road, the three-dimensional entity models such as road, bridge, tunnel and road affiliated facility are quickly established, and by parametric designing, realize road engineering model three-dimensional visualization; the design and realization of highway three-dimension visible system, realize the visualization of three-dimensional road engineering model; render the foundation of texture database, it is realized by the mode in texture mapping to model, so in order to allow the visualization of model that can really reflect scene in kind, it is necessary to establish texture database abundant enough, including vegetation, flowers and plants, three-D grain textures etc., the fidelity of system vision has been continuously improved. Here, a special significance to texture and specific application may be provided. However, for a broad spectrum use the availability of the system for various devices, formats and runtime environments may not be present.

Further, granted U.S. Pat. No. 11,538,217 provides for an augmented reality system. The system receives values of parameters of real-world elements of an augmented reality environment from various sensors and creates a three-dimensional textual matrix of sensor representation of a real environment world based on the parameters. The system determines a context of a specific virtual object with respect to the real-world environment based on the three-dimensional textual matrix. The system then models the specific virtual object based on the context to place the specific virtual object in the augmented reality environment.

U.S. Pat. No. 10,672,189B2 proposes a cloud network server system, a method, and a software program product for compiling and presenting a three-dimensional (3D) model. An end 3D model is composed from at least two pre-existing 3D models stored in the cloud network server system by combining the pre-existing 3D models. The end 3D model is partitioned into smaller cells. The system and method allow a drawing user to view and draw the end 3D model for example of a computer game, via a drawing user terminal computer. Based on a virtual location of the drawing user in the end 3D model, parts of at least one version of the end 3D model are rendered to the drawing user. The system and method render a more lifelike virtual reality gaming experience with substantially lesser time lag, lesser memory footprint requirement, and lesser production effort. Although improvements due to the existence of 3D models beforehand may be achieved, integration of various formats and inclusion of specific details for broad spectrum optimization may be missing.

There is therefore a need for a versatile modelling and rendering system and method to allow various format models to be rendered in various real time rendering devices at ease.

### SUMMARY OF THE INVENTION

Accordingly, the present invention provides a method of dynamic and runtime, generation and rendering of a reconstructed model, of a formatted three dimensional model having defined format features, the method comprising the steps of:
a. intermittently receiving device features of a rendering device;
b. intermittently receiving a desired visual effect data;
c. generation of a set of modeling inputs for said three dimensional model to be used to generate the reconstructed model.

In an embodiment, the steps of: applying a partitioning method on said formatted three dimensional model based at least upon the said set of modeling inputs; applying a simplification method; and, creating the reconstructed model on the basis of simplified vertices, may be provided.

In one another embodiment, the said defined file format features involve storing the mapping of said modeling inputs.

In still another embodiment, the said formatted three dimensional model provides for a secure format, readability of contents only in certain environments, being compressed in size, and cross platform file type.

In one embodiment the format features includes storing of mapping of various modeling inputs including polycount, size in MB of model, size of textures, UV map sizes, surface type, and curvature of various existing contemporary modeling formats.

In yet another embodiment, the desired visual effect data needed in the rendered model, includes camera resolution, real lighting, distance from camera, orientation and position in viewport.

In still another embodiment, the rendering device features includes CPU, RAM, temperature, GPU, disk storage, screen resolution, Platform, type of experience, type of browser or standalone device.

In another embodiment, the partitioning and simplification methods include the nearest point algorithm method. Further, in another embodiment, the partitioning and simplification methods include simplifying on the number of points in a cluster and accounting for textures.

In yet another embodiment, the partitioning and simplification methods include curvature based segmentation, comprising steps of: making clusters curvature dependent, changing a normal thresholding and curvature thresholding and including curvature values in cluster representation. Further, in one embodiment the partitioning and simplification methods include providing higher priority of vertex density in areas of higher interest.

In one embodiment, the present invention provides that the a computer program product, comprising: a non-transitory computer readable storage medium comprising computer readable program code embodied in the medium that is executable by one or more processors of a computing device for dynamic and runtime, generation and rendering of a reconstructed model, of a formatted three dimensional model having defined format features, wherein the one or more processors perform:
a. intermittently receiving device features of a rendering device;
b. intermittently receiving a desired visual effect data;
c. generation of a set of modeling inputs for said three dimensional model to be used to generate the reconstructed model.

Further, the present invention provides that the computer program product wherein the one or more processors perform:
a. applying a partitioning method on said formatted three dimensional model based at least upon the said set of modeling inputs;
b. applying a simplification method; and,
c. creating the reconstructed model on the basis of simplified vertices.

In an embodiment, the format features includes storing of mapping of various modeling inputs including polycount, size in MB of model, size of textures, UV map sizes, surface type, and curvature of various existing contemporary modeling formats. In yet another embodiment, the desired visual effect data needed in the rendered model, includes camera resolution, real lighting, distance from camera, orientation and position in viewport.

In still another embodiment, generation and rendering of a reconstructed model, of a formatted three dimensional model having defined format features, as in claim 1, wherein the rendering device features includes CPU, RAM, temperature, GPU, disk storage, screen resolution, Platform, type of experience, type of browser or standalone device.

In one embodiment, a system for dynamic and runtime, generation and rendering of a reconstructed model, of a formatted three dimensional model having defined format features comprising: a storage device configured to store the formatted three dimensional model having defined format features; a processing unit configured to intermittently receive device features of a rendering device and intermittently receive a desired visual effect data; and generate a set of modeling inputs for said three dimensional model to be used to generate the reconstructed model.

In one embodiment the processing unit is configured to apply a partitioning method on said formatted three dimensional model based at least upon the said set of modeling inputs, and apply a simplification method and, creating the reconstructed model on the basis of simplified vertices.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 shows a system for automatic and dynamic generation of modelling inputs based on a defined set of rendering variables, and rendering a reconstructed and optimized model in real time as per an embodiment herein.

FIG. 2 shows an exemplary ecosystem comprising a real life visual and three dimensional object therein and optimization thereof as per an embodiment herein.

FIG. 3 illustrates a flow diagram of the steps involved in a method for generation of a specific file format having a defined format features, to enable automatic and dynamic generation of modelling inputs based on a defined set of rendering variables, during realtime as per an embodiment herein.

FIG. 4 shows a method for automatic and dynamic generation of modelling inputs based on a defined set of rendering variables as per an embodiment herein.

FIG. 5 illustrates a flow diagram of the steps involved in a method for rendering of model created using automatic and dynamic generation of modelling inputs based on a defined set of rendering variables as per an embodiment herein.

### DETAILED DESCRIPTION OF THE PREFERRED EMBODIMENTS

A system and method for automatic and dynamic generation of modelling inputs based atleast upon a defined set of rendering variables, and rendering a reconstructed and optimized model in realtime is described. The rendering variables may have bearing on the rendering device features such as, for example: CPU, RAM, temperature, GPU, disk storage, screen resolution, Platform (web/standalone), (type of browser/standalone device). The rendering variables may also have bearing on the kind of visual effect needed in the rendered model, such as, for example: camera resolution, real lighting, distance from camera, orientation and position in viewport.

The following description is set forth for the purpose of explanation in order to provide an understanding of the invention. However, it is apparent that one skilled in the art will recognize that embodiments of the present invention, some of which are described below, may be incorporated into a number of computer modelling methods and systems. Structures shown in the diagrams are illustrative of exemplary embodiments of the invention and are meant to avoid obscuring the invention. Furthermore, connections between components within the figures are not intended to be limited to direct connections. Rather, connection/s between these components may be modified, re-arranged or otherwise changed by intermediary components.

Reference in the specification to “one embodiment”, “in one embodiment” or “an embodiment” etc. means that a particular feature, structure, characteristic, or function described in connection with the embodiment is included in at least one embodiment of the invention. The appearances of the phrase “in one embodiment” in various places in the specification are not necessarily all referring to the same embodiment. Further, it may be noted that reference to a model includes reference to one or more models. This makes clearer the possibility of practicing the method and system of the current invention on more than one model at the same time.

The memory or storage device is a non-transitory computer readable storage medium, for example, the memory unit for storing programs and data. As used herein, “non-transitory computer readable storage medium” refers to all computer readable media, for example, non-volatile media, volatile media, and transmission media, except for a transitory, propagating signal. Non-volatile media comprise, for example, solid state drives, optical discs or magnetic disks, and other persistent memory volatile media including a dynamic random access memory (DRAM), which typically constitute a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to the microprocessor. The memory unit is, for example, a random access memory (RAM) or another type of dynamic storage device that stores information and instructions for execution by the processor. The memory unit also stores temporary variables and other intermediate information used during execution of the instructions by the processor. The embedded microcomputer further comprises a read only memory (ROM) or another type of static storage device that stores static information and instructions for the processor.

The network is, for example, one of the internet, an intranet, a wired network, a wireless network, a communication network that implements Bluetooth® of Bluetooth Sig, Inc., a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, a public telephone network, etc., a local area network, a wide area network, an internet connection network, an infrared communication network, etc., or a network formed from any combination of these networks. In an embodiment, the captured data are accessible to the user, for example, through a broad spectrum of technologies and devices such as cellular phones, tablet computing devices, etc., with access to the internet.

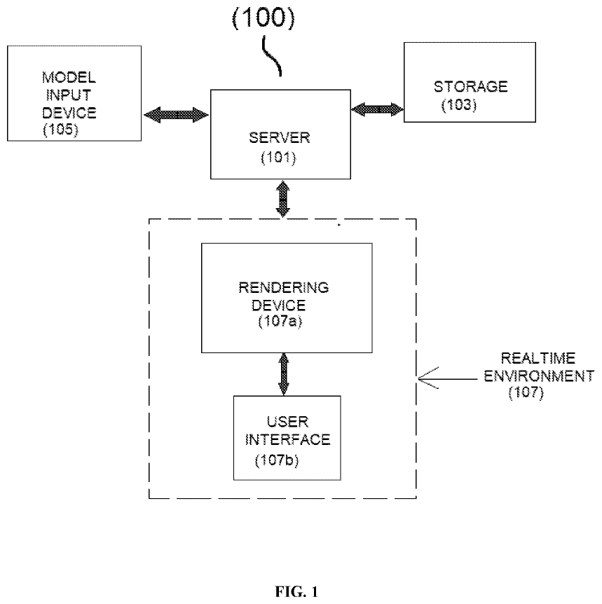

As per an embodiment as shown in FIG. 1, a system for automatic and dynamic generation of modelling inputs based on a defined set of rendering variables, and rendering a reconstructed and optimized model in realtime is described.

In one embodiment, the system may comprise a server (101) or a central processing device, configured to receive a computer three dimensional model from a creator. This may be done by the creator using a model input device (105). A server or a central processing device may be configured to receive this model. In another embodiment, the output of the model input device may be further modified before the same is received by the server. The devices may be connected over a network of devices, or a network.

The server may be configured to receive the three-dimensional model in various formats and convert the same into a specific file format having a defined format features. The converted model may be stored in the storage device/memory (103). The formatted three dimensional model having defined format features of various contemporary three dimension model formats may be provided. Further, features of new 3D model formats may be provided to allow for functioning of the said system with various base 3D format. The base format may be created using a model input device 105. While the formatted three dimensional model may be stored in the storage 103 which in one embodiment may be present communicatively coupled to a server. Alternatively it may be present locally in a computing system. The formatted model stored in the server may be accessed anytime and easily reconstructed at runtime, dynamically.

A realtime environment (107) may atleast comprise a rendering device (107a) connected with the server over a network. Upon a request by the realtime environment, the server may be configured to receive the realtime environment related information. This may include rendering variables having rendering device related details as well as the kind of visual effect desired. The server may also be configured to receive the specific file format having defined features, and processing the same to produce a reconstructed model to be sent to a realtime environment. The server may be configured to apply various partitioning methods, simplification methods, and reconstruct the model based on simplified vertices. This may be sent to the realtime environment where the same may be optimized and rendered based on the user interface (107b) and other features of the realtime environment.

In one embodiment, a dynamic and runtime optimization of the reconstructed model to use the resources when needed is provided. This allows for instantaneous optimization based on dynamic features. A dedicated resource for a predefined activity may no longer be needed, allowing for efficient use of the resources at runtime.

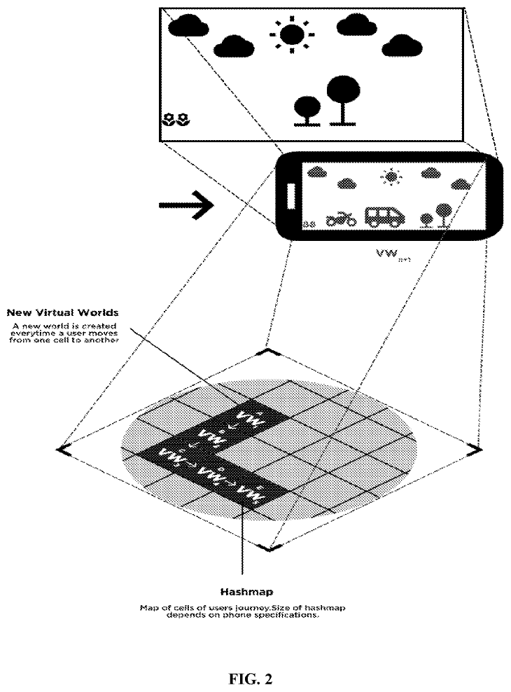

The optimization may be based on whether or not the calculations to partition, simplify, and reconstruct need to happen since they are or can be performance intensive. As an example, if there is no input or if there is no change in device specs/other influencing parameters, the system is configured to not render frames. In one embodiment this may be done by utilizing a 3D textual matrix/grid as shown in FIG. 2, which would allow for a structured way of caching the rendered quality from each cell. The real/virtual area may be divided into cells. These cells may store a pre-computed rendering quality/vertices and would allow for the reduction of calculations every frame. As another example, if the viewport and position of the camera is overlapping a cell in the grid/matrix which has pre-computed modeling information, the same may get applied without the need for a computation.

Further, the system is configured to enable interplay among models. Based on the device's render capability, awareness on a pool of resources to work with may be had. In a scenario where we render more than one model, the system allows for sharing resources and as per priority, and decides the level of detail/vertices/quality/complexity to be used for each of the model. The system provides for rendering high quality levels of detail looking at the importance of a model as compared to the other models in the scene. For example, the weightage given to a car may be more than the trees around it. Accordingly the car may be given more detailing in a model as compared to the other object, say, a tree.

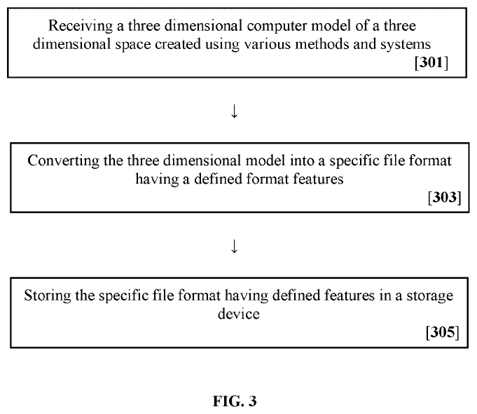

FIG. 3 shows a method for generation of a specific file format having a defined format features, to enable automatic and dynamic generation of modelling inputs based on a defined set of rendering variables, during realtime as per an embodiment herein.

The method comprises the steps of receiving a three dimensional computer model of a three dimensional space/object created using various methods and systems (201). In one embodiment the model may be in FBX (Filmbox), a proprietary file format (.fbx) developed by Kaydara and owned by Autodesk. In another embodiment, DAE format which is a 3D interchange file used for exchanging digital assets between a variety of graphics programs may be used. It may contain an image, textures, or most likely, a 3D model. The DAE format is based on the COLLADA (COLLAborative Design Activity) XML schema, which is now owned and developed by Autodesk. In yet another embodiment, a GLB format may be used that's used in virtual reality (VR), augmented reality (AR), games, and web applications because it supports motion and animation. Another advantage of the format is its small size and fast load times. GLB files are a binary version of the GL Transmission Format (glTF) file, which uses JSON (JavaScript Object Notation) encoding. So, supporting data (like textures, shaders, and geometry/animation) is contained in a single file. The Khronos Group developed the GLB and glTF formats. In yet another embodiment, the model may be in OBJ format first developed by Wavefront Technologies for its Advanced Visualizer animation package. Other file formats may also be supported. The receiving of the three dimensional model may happen at a server location uploaded by a creator from their device. This three dimensional model may be preexisting or created afresh.

Further step comprises converting the three dimensional model into a specific file format having a defined format features (303). In one embodiment this specific file format may be .CLAY format. In one embodiment the said defined file format features (such as for example tiling, texture file format, animations) may involve storing the mapping of various modelling inputs such as, for example: polycount, size in MB of model, size of textures, UV map sizes, surface type, curvature. This may help in providing quick output of a desired three dimensional model at realtime. Further, the said format may provide for features such as, for example: Secure format, contents only readable in certain environments, being compressed in size, and cross platform file type.

In one embodiment, further step comprises storing the specific file format having defined features in a storage device (305). In one embodiment, the said storage may be in the cloud, allowing quick access through the Internet.

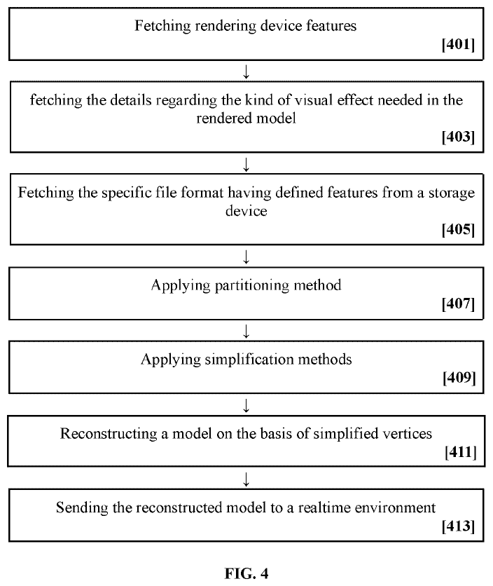

FIG. 4 shows a method for automatic and dynamic generation of modelling inputs based on a defined set of rendering variables as per an embodiment herein.

In one embodiment, the method for automatic and dynamic generation of modelling inputs based on a defined set of rendering variables may comprise the step of receiving rendering device features (401). For example, these may be CPU, RAM, temperature, GPU, disk storage, screen resolution, platform (web/standalone), (type of browser/standalone device). Further, as per an embodiment, the step may include, receiving the details regarding the kind of visual effect needed in the rendered model (403). For example: camera resolution, real lighting, distance from camera, orientation and position in viewport.

Further, in one embodiment, receiving the specific file format having defined features from a storage device may take place (405). The storage device may be local to the rendering device or may be present in a cloud location. Applying partitioning method (407) may take place upon the specific file format having defined features. This may help in making the model compact and uniform.

In one embodiment, the further step may comprise of applying simplification methods (409). Exemplary embodiments present methods such as the nearest point method, the curvature based segmentation method, processing the high areas of interest, identifying and processing of viewport and manual input.

Reconstructing a model on the basis of simplified vertices (411) may then take place in one embodiment herein. This may allow for dynamic level of details and provisioning of real time results.

Further step in one embodiment may involve sending the reconstructed model to a realtime environment (413). This may be present in the server itself or the rendering device.

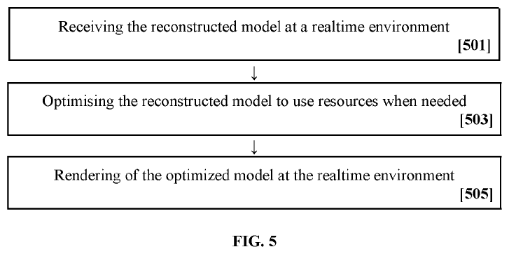

FIG. 5 shows a method for rendering a model created using automatic and dynamic generation of modelling inputs based on a defined set of rendering variables as per an embodiment herein.

The method described may comprise the step of receiving the reconstructed model at a realtime environment (501). Various real time environments may be supported. Further, various devices such as mobile, desktop computers, tablets, special purpose computing devices, computer user interface, graphical user interface may be supported for rendering.

In one embodiment, the further step may comprise of optimising the reconstructed model to use resources when needed (503). As an example, this may include a method to avoid rendering of frames based on the detection of absence of input. Another example, may include avoiding rendering of frames based on detection of absence of change in device specifications/other influencing parameters. This change may be specified with a help of a threshold delta value.

Rendering of the optimized model at the realtime environment (505) may then take place in one embodiment. Various realtime environments such as, for example: virtual reality, three dimensional, two dimensional, augmented reality, mixed reality environments may be supported.

The method provides for dynamic and runtime, generation and rendering of a reconstructed model, of a formatted three dimensional model having defined format features. The server may be configured to be intermittently receiving device features of a rendering device and a desired visual effect data. In one embodiment, the desired visual effect data needed in the rendered model, includes camera resolution, real lighting, distance from camera, orientation and position in viewport. In one embodiment, the rendering device features includes CPU, RAM, temperature, GPU, disk storage, screen resolution, Platform, type of experience, type of browser or standalone device.

In one embodiment, the format features includes storing of mapping of various modeling inputs including polycount, size in MB of model, size of textures, UV map sizes, surface type, and curvature of various existing contemporary modeling formats. The said formatted three dimensional model also provides for a secure format, readability of contents only in certain environments, being compressed in size, and cross platform file type. Also, the said defined file format features involve storing the mapping of said modeling inputs.

The method may further provide for generation of a set of modeling inputs for said three dimensional model to be used to generate the reconstructed model. A partitioning method on said formatted three dimensional model based at least upon the said set of modeling inputs may be applied.

Furthermore, applying a simplification method and creating the reconstructed model on the basis of simplified vertices takes place.

In one embodiment, the partitioning and simplification methods include the nearest point algorithm method. Further, steps for simplifying on the number of points in a cluster and accounting for textures are provided. Also, curvature based segmentation, comprising steps of: making clusters curvature dependent, changing a normal thresholding and curvature thresholding and including curvature values in cluster representation may be provided.

Furthermore, the partitioning and simplification methods include providing higher priority of vertex density in areas of higher interest. Accordingly, the system provides for rendering high quality levels of detail looking at the importance of a model as compared to the other models in the scene. For example, the weightage given to a car may be more than the trees around it, accordingly the car may be given more detailing in a model as compared to the other object, say, a tree.

Further, the system is configured to enable interplay among models. Based on the device's render capability, awareness on a pool of resources to work with may be had. In a scenario where we render more than one model, the system allows for sharing resources, and as per priority, decides the level of detail/vertices/quality/complexity to be used for each of the models.

The foregoing description of the invention has been described for purposes of clarity and understanding. It is not intended to limit the invention to the precise form disclosed. Various modifications may be possible within the scope and equivalence of the description and the claims.

1. A method of dynamic and runtime, generation and rendering of a reconstructed model, of a formatted three dimensional computer model having defined format features, the method comprising the steps of:
intermittently receiving device features of a rendering device;
intermittently receiving a desired visual effect data; and
generating a set of modeling inputs for said three dimensional computer model to be used to generate the reconstructed model.

2. The method of dynamic and runtime, generation and rendering of a reconstructed model, of a formatted three dimensional computer model having defined format features, as in claim 1, further comprising the steps of:
applying a partitioning method on said formatted three dimensional computer model based at least upon the said set of modeling inputs;
applying a simplification method; and,
creating the reconstructed model on the basis of simplified vertices.

3. The method of dynamic and runtime, generation and rendering of a reconstructed model, of a formatted three dimensional computer model having defined format features, as claimed in claim 1, wherein:
the said defined file format features involve storing the mapping of said modeling inputs.

4. The method of dynamic and runtime, generation and rendering of a reconstructed model, of a formatted three dimensional computer model having defined format features, as claimed in claim 1, wherein the said formatted three dimensional computer model provides for a secure format, readability of contents only in certain environments, being compressed in size, and cross platform file type.

5. The method of dynamic and runtime, generation and rendering of a reconstructed model, of a formatted three dimensional computer model having defined format features, as claimed in claim 1, wherein the format features includes storing of mapping of various modeling inputs including polycount, size in MB of model, size of textures, UV map sizes, surface type, and curvature of various existing contemporary modeling formats.

6. The method of dynamic and runtime, generation and rendering of a reconstructed model, of a formatted three dimensional computer model having defined format features, as in claim 1, wherein the desired visual effect data needed in the rendered model, includes camera resolution, real lighting, distance from camera, orientation and position in viewport.

7. The method of dynamic and runtime, generation and rendering of a reconstructed model, of a formatted three dimensional computer model having defined format features, as in claim 1, wherein the rendering device features includes CPU, RAM, temperature, GPU, disk storage, screen resolution, Platform, type of experience, type of browser or standalone device.

8. The method of dynamic and runtime, generation and rendering of a reconstructed model, of a formatted three dimensional computer model having defined format features, as in claim 2, wherein the partitioning and simplification methods include the nearest point algorithm method.

9. The method of dynamic and runtime, generation and rendering of a reconstructed model, of a formatted three dimensional computer model having defined format features, as in claim 2, wherein the partitioning and simplification methods include simplifying on the number of points in a cluster and accounting for textures.

10. The method of dynamic and runtime, generation and rendering of a reconstructed model, of a formatted three dimensional computer model having defined format features, as in claim 2, wherein the partitioning and simplification methods include curvature based segmentation, comprising steps of: making clusters curvature dependent, changing a normal thresholding and curvature thresholding and including curvature values in cluster representation.

11. The method of dynamic and runtime, generation and rendering of a reconstructed model, of a formatted three dimensional computer model having defined format features, as in claim 2, wherein the partitioning and simplification methods include providing higher priority of vertex density in areas of higher interest.

12. A computer program product, comprising: a non-transitory computer readable storage medium comprising computer readable program code embodied in the medium that is executable by one or more processors of a computing device for dynamic and runtime, generation and rendering of a reconstructed model, of a formatted three dimensional computer model having defined format features, wherein the one or more processors perform:
intermittently receiving device features of a rendering device;
intermittently receiving a desired visual effect data; and
generating a set of modeling inputs for said three dimensional computer model to be used to generate the reconstructed model.

13. The computer program product of claim 12, wherein the one or more processors perform: applying a partitioning method on said formatted three dimensional computer model based at least upon the said set of modeling inputs;
applying a simplification method; and,
creating the reconstructed model on the basis of simplified vertices.

14. The computer program product of claim 12, wherein the format features includes storing of mapping of various modeling inputs including polycount, size in MB of model, size of textures, UV map sizes, surface type, and curvature of various existing contemporary modeling formats.

15. The computer program product of claim 12, wherein the desired visual effect data needed in the rendered model, includes camera resolution, real lighting, distance from camera, orientation and position in viewport.

16. The computer program product of claim 12, wherein generation and rendering of a reconstructed model, of a formatted three dimensional computer model having defined format features, as in claim 1, wherein the rendering device features includes CPU, RAM, temperature, GPU, disk storage, screen resolution, Platform, type of experience, type of browser or standalone device.

17. A system for dynamic and runtime, generation and rendering of a reconstructed model, of a formatted three dimensional computer model having defined format features comprising:
a storage device configured to store the formatted three dimensional computer model having defined format features; and
a processing unit configured to intermittently receive device features of a rendering device and intermittently receive a desired visual effect data; and generate a set of modeling inputs for said three dimensional computer model to be used to generate the reconstructed model.

18. The system as in claim 17, wherein the processing unit is configured to apply a partitioning method on said formatted three dimensional computer model based at least upon the said set of modeling inputs, apply a simplification method and create the reconstructed model on the basis of simplified vertices.
